(19) United States
(12) Patent Application Publication
(10) Pub. No.: US 2011/0296692 A1
(43) Pub. Date: Dec. 8, 2011

(54) Utensil that is Decomposed Naturally and the Method for Making It

(76) Inventor: Chien-Hsin Chao, Xiushui Township (TW)

(21) Appl. No.: 12/795,788

(22) Filed: Jun. 8, 2010

(51) Int. Cl. B26B 3/00; B29C 43/22; B24B 1/00

(52) U.S. Cl. 30/142; 451/28; 264/70

(57) ABSTRACT

A method for making a utensil includes a first step of placing and stirring a mixture containing a melamine resin of 30-60%, a bamboo fiber powder of 30-60% and an adjuvant of 5% to form an evenly distributed first blank, a second step of cooling the first blank to form a second blank, a third step of pressing and molding the second blank to form a semi-product, and a fourth step of polishing the semi-product to form a final product of the utensil. Thus, all of the melamine resin, the bamboo fiber powder and the adjuvant are made of organic material so that the utensil can be decomposed naturally and will not pollute the environment when it is disposed of to achieve the environmental protection purpose.

### BACKGROUND OF THE INVENTION

1. Field of the Invention

The present invention relates to a household utensil, such as a dishware and the like, and, more particularly, to a utensil and the method for making the utensil.

2. Description of the Related Art

A conventional melamine utensil comprises melamine resin and corn powder which are mixed together. However, the melamine utensil is made of the corn material so that the melamine utensil will consume and waste the foodstuff of the natural resource. In addition, the melamine utensil is made of the corn material so that the melamine utensil has a higher price. Further, the melamine utensil is made of the corn material so that the melamine utensil easily produces bacteria and mildews.

### BRIEF SUMMARY OF THE INVENTION

In accordance with the first feature of the present invention, there is provided a utensil, comprising a melamine resin of 30-60%, a bamboo fiber powder of 30-60% and an adjuvant of 5%.

In accordance with the second feature of the present invention, there is provided a method for making a utensil, comprising a first step of placing and stirring a mixture containing a melamine resin of 30-60%, a bamboo fiber powder of 30-60% and an adjuvant of 5% to form an evenly distributed first blank, a second step of cooling the first blank to form a second blank, a third step of pressing and molding the second blank to form a semi-product, and a fourth step of polishing the semi-product to form a final product of the utensil.

The primary objective of the present invention is to provide a utensil that is decomposed naturally to achieve an environmental protection purpose and has energy-saving and carbon reduction functions.

According to the primary advantage of the present invention, all of the melamine resin, the bamboo fiber powder and the adjuvant are made of organic material so that the utensil can be decomposed naturally and will not pollute the environment when it is disposed of to achieve the environmental protection purpose.

According to another advantage of the present invention, the utensil is made of the bamboo fiber powder so that the utensil will not consume the foodstuff of the natural resource.

According to a further advantage of the present invention, the utensil is made of the bamboo fiber powder instead of the trees to prevent the forest from being logged and exhausted.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of a utensil in accordance with the preferred embodiment of the present invention.

FIG. 2 is a flow chart of a method for making the utensil as shown in FIG. 1.

### DETAILED DESCRIPTION OF THE INVENTION

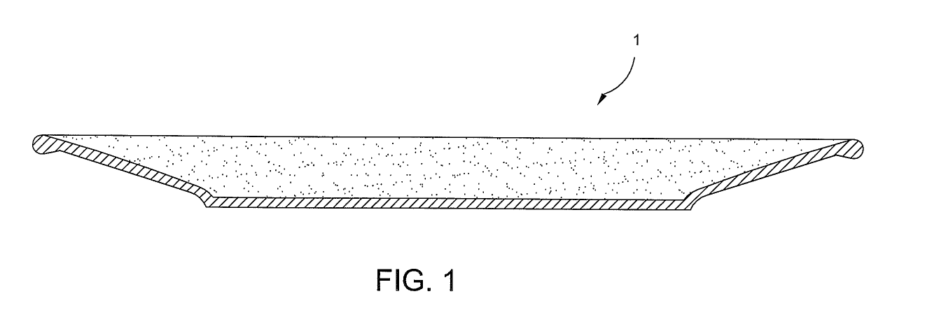

Referring to the drawings and initially to FIG. 1, a utensil 1 in accordance with the preferred embodiment of the present invention comprises a melamine resin 10 of 30-60%, a bamboo fiber powder 12 of 30-60% and an adjuvant 14 of 5%.

The melamine resin 10 is made of an organic material. The melamine resin 10 has a greater hardness and has a smooth surface. The bamboo fiber powder 12 is made of an organic material. The bamboo fiber powder 12 has greater strength and malleability. The adjuvant 14 is made of an organic material. The adjuvant 14 has an adhesive feature.

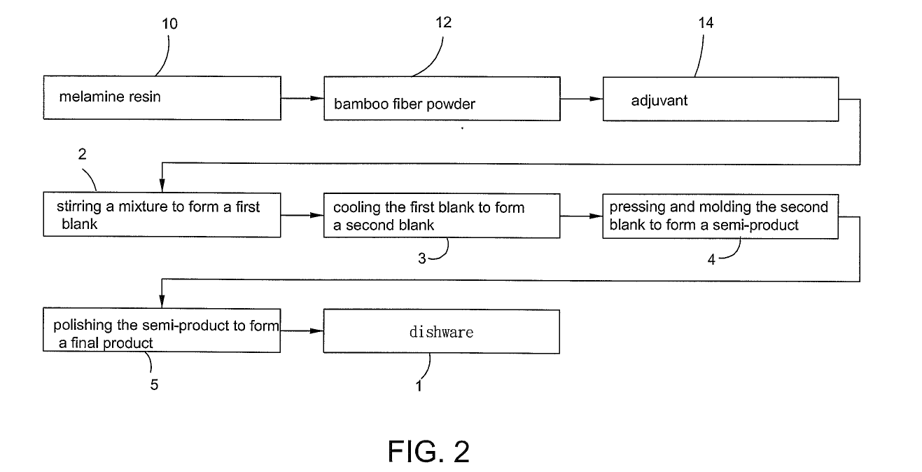

Referring to FIG. 2, a method for making a utensil 1 in accordance with the preferred embodiment of the present invention comprises a first step of placing and stirring a mixture containing a melamine resin 10 of 30-60%, a bamboo fiber powder 12 of 30-60% and an adjuvant 14 of 5% to form an evenly distributed first blank 2, a second step of cooling the first blank 2 to form a second blank 3, a third step of pressing and molding the second blank 3 to form a semi-product 4, and a fourth step of polishing the semi-product 4 to form a final product of the utensil 1.

In the first step, the mixture is placed into, stirred and reacted evenly in a stirring reaction barrel that is operated at a high speed. In addition, in the first step, the mixture is stirred at a temperature about 80° C. In the second step, the first blank 2 is cooled in a cooling barrel. In addition, in the second step, the first blank 2 is cooled to a temperature about 20° C. In the third step, the second blank 3 is pressed and molded by a hydraulic molding press. In addition, in the third step, the semi-product 4 is formed at a temperature about 160 to 180° C. In the fourth step, the semi-product 4 is polished by a polishing machine to polish a rough surface of the semi-product 4.

Accordingly, all of the melamine resin 10, the bamboo fiber powder 12 and the adjuvant are made of organic material so that the utensil 1 can be decomposed naturally and will not pollute the environment when it is disposed of so as to achieve the environmental protection purpose. In addition, the utensil 1 is made of the bamboo fiber powder 12 so that the utensil 1 will not consume the foodstuff of the natural resource. Further, the utensil 1 is made of the bamboo fiber powder 12 instead of the trees to prevent the forest from being logged and exhausted.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A utensil, comprising:
a melamine resin of 30-60%;
a bamboo fiber powder of 30-60%; and
an adjuvant of s5%.

2. The utensil of claim 1, wherein the adjuvant is made of an organic material and has an adhesive feature.

3. A method for making a utensil, comprising:
a first step of placing and stirring a mixture containing a melamine resin of 30-60%, a bamboo fiber powder of 30-60% and an adjuvant of 5% to form an evenly distributed first blank;
a second step of cooling the first blank to form a second blank;
a third step of pressing and molding the second blank to form a semi-product; and
a fourth step of polishing the semi-product to form a final product of the utensil.

4. The method for making a utensil of claim 3, wherein in the first step, the mixture is placed into, stirred and reacted evenly in a stirring reaction barrel that is operated at a high speed.

5. The method for making a utensil of claim 3, wherein in the first step, the mixture is stirred at a temperature about 80° C.

6. The method for making a utensil of claim 3, wherein in the second step, the first blank is cooled in a cooling barrel.

7. The method for making a utensil of claim 3, wherein in the second step, the first blank is cooled to a temperature about 20° C.

8. The method for making a utensil of claim 3, wherein in the third step, the second blank is pressed and molded by a hydraulic molding press.

9. The method for making a utensil of claim 3, wherein in the third step, the semi-product is formed at a temperature about 160 to 180° C.

10. The method for making a utensil of claim 3, wherein in the fourth step, the semi-product is polished by a polishing machine to polish a rough surface of the semi-product.
